(19) United States
(12) Patent Application Publication
(10) Pub. No.: US 2004/0051767 A1
(43) Pub. Date: Mar. 18, 2004

(54) Pressure absorbing apparatus, ejector apparatus and methods

(75) Inventor: Yutaka Takano, Nagano-ken (JP)

Correspondence Address: SHINJYU GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 10/612,295

(22) Filed: Jul. 3, 2003

(30) Foreign Application Priority Data
Jul. 4, 2002 (JP) 2002-196460

(51) Int. Cl. B41J 2/17

(52) U.S. Cl. 347/94

(57) ABSTRACT

A pressure absorbing apparatus is disposed between a tank for a liquid and an ejecting head that ejects the liquid from the tank onto an ejection object. The pressure absorbing apparatus is configured such that droplets are ejected from the ejecting head in a stable manner irrespective of the properties of the liquid. A corrosion-resistant material is used to form the surfaces of a droplet inlet, a droplet outlet, a channel, and the pressure absorbing portion that contact the liquid. This pressure absorbing apparatus is used in an ejector apparatus, that can be used to manufacture an electrooptical device having a color filter or an EL element, and that can be used to manufacture an electronic apparatus with this electrooptical device. A device having a base is manufactured with an ejected pattern that is formed by using the ejector apparatus.

### BACKGROUND OF THE INVENTION

1. Field of the Invention

The present invention generally relates to a pressure absorbing apparatus such as a pressure damper used in an ejector apparatus that ejects a liquid such as ink onto an ejection object. This ejector apparatus with the pressure absorbing apparatus can be used to manufacture an electrooptical device having a color filter or an EL element, an electronic apparatus with this electrooptical device and a device having a base with an ejected pattern.

2. Background Information

Electrooptical devices having color filters, electroluminescence elements (EL elements), and the like are currently used on a wide scale. A color filter or an EL element is formed by applying or ejecting a liquid material for a color filter or a liquid material in a dotted configuration on a substrate. Specifically, droplets containing a filter material or an EL emission material are ejected from an ejecting head while the ejecting head is horizontally scanned a plurality of times over the substrate.

Stable ejection of droplets is difficult to maintain during the scanning of the ejecting head because acceleration is applied to the droplets in the ejecting head and to the droplets in the tube that connects the ejecting head and the tank, causing the feed pressure of the droplets to fluctuate. In view of this, methods have been devised in the past whereby pressure absorbing apparatuses installed in ejector apparatuses for ink jet printers are used during the manufacture of color filters or EL elements.

It has been discovered that such pressure absorbing apparatuses are resistant solely to water-soluble liquid bodies or inks and tend to sustain damage when used in the manufacture of color filters or EL elements that employ special solvents or the like.

In view of the above, it will be apparent to those skilled in the art from this disclosure that there exists a need for an improved pressure absorbing apparatus that is used in an ejector apparatus, which can be used to manufacture an electrooptical device having a color filter or an EL element, an electronic apparatus with this electrooptical device and a device having a base with an ejected pattern. This invention addresses this need in the art as well as other needs, which will become apparent to those skilled in the art from this disclosure.

### SUMMARY OF THE INVENTION

One object of the present invention, which was devised in view of such a drawback, is to provide a pressure absorbing apparatus capable of ejecting droplets from the ejecting head in a stable manner irrespective of the properties of the liquid. Also an object of the present invention is to provide an ejector apparatus having this pressure absorbing apparatus that is used to provide an electrooptical device having a color filter or EL element, a device having a base with an ejected pattern, and an electronic apparatus having this electrooptical device.

The pressure absorbing apparatus of the present invention is to be disposed between a tank for a liquid and an ejecting head that ejects the liquid from the tank onto an ejection object. The pressure absorbing apparatus basically comprises a droplet inlet, a droplet outlet, a channel and a pressure absorbing portion. The droplet inlet is configured to be fluidly connected to the tank. The droplet outlet is configured to be fluidly connected to the ejecting head. The channel is fluidly connecting the droplet inlet to the droplet outlet. The pressure absorbing portion is in communication with the channel. The pressure absorbing apparatus absorbing the pressure fluctuations in the liquid being fed from the tank to the ejecting head. At least surfaces of the droplet inlet, the droplet outlet, the channel, and the pressure absorbing portion that are arranged to contact the liquid are formed of a corrosion-resistant material that resists corrosion by the liquid.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a perspective view depicting a manufacturing apparatus in accordance with a first embodiment of the present invention;

FIG. 2 is an exploded perspective view depicting an ejector apparatus of the manufacturing apparatus illustrated in FIG. 1 in accordance with the first embodiment of the present invention;

FIG. 3 is a perspective view of the ejector apparatus illustrated in FIG. 2 in accordance with the first embodiment of the present invention;

FIG. 4 is a cross-sectional view depicting a color filter manufactured with the aid of the manufacturing apparatus illustrated in FIG. 1 in accordance with the first embodiment of the present invention;

FIG. 5 is a cross-sectional view depicting an electrooptical device having the color filter manufactured with the aid of the manufacturing apparatus illustrated in FIG. 1 in accordance with the first embodiment of the present invention;

FIG. 6 is a perspective view depicting a personal computer equipped with the electrooptical device manufactured with the aid of the manufacturing apparatus illustrated in FIG. 1 in accordance with the first embodiment of the present invention;

FIG. 7 is a perspective view depicting a portable phone equipped with the electrooptical device manufactured with the aid of the manufacturing apparatus illustrated in FIG. 1 in accordance with the first embodiment of the present invention;

FIG. 8 is a circuit diagram of the light emitting apparatus in accordance with a second embodiment of the present invention;

FIG. 9 is a top plan view depicting a planar structure including pixel regions of the light emitting apparatus manufactured with the aid of the manufacturing apparatus illustrated in FIG. 1 in accordance with the second embodiment of the present invention;

FIG. 10 is a cross-sectional view of the light emitting apparatus as seen along section line A-B in FIG. 9 in accordance with the second embodiment of the present invention; and

FIG. 11 is an enlarged, partial cross-sectional view depicting a part of the light emitting apparatus illustrated in FIG. 10 in accordance with the second embodiment of the present invention.

### DETAILED DESCRIPTION OF THE PREFERRED EMBODIMENTS

Basically, in the present invention, a surface of a pressure absorbing apparatus that is in contact with a liquid is covered with a corrosion-resistant material, making it possible to prevent the pressure absorbing apparatus from being damaged by the corrosion or the like of the surface in contact with the liquid. It is therefore possible to eject droplets from an ejecting head in a stable manner, irrespective of the properties of the liquid. Because the droplets can be stably ejected in this manner, it is possible to reduce the percent of defective devices and to increase productivity.

The pressure absorbing apparatus of the present invention can be covered with a corrosion-resistant material solely along the surface of the droplet inlet, droplet outlet, channel, and pressure absorbing portion in contact with the liquid, or the entire structure can be composed of the corrosion-resistant material.

In this situation, the corrosion-resistant material is preferably at least one material selected from among polyethylene, polypropylene, fluororesin, polyoxymethylene, cyclic olefin copolymer, and polyparaphenylene benzoxazole.

Examples of suitable fluororesins include tetrafluoroethylene-perfluoroalkyl (PFA) vinyl ether copolymers, polytetrafluoroethylene (PTFE), and polychlorotrifluoroethylene (PCTFE).

Polyethylene (PE), polypropylene (PP), fluororesin, polyoxymethylene (POM), cyclic olefin copolymer (COC), or poly(p-phenylene-2,6-benzobisoxazole) (PBO) can be used as the corrosion-resistant material during the manufacture of an EL element. In addition, using polyethylene or cyclic olefin copolymer during the manufacture of a color filter is particularly preferred.

For example, a liquid obtained by dissolving a material for an EL layer or a material for a color filter in a special organic solvent is used during the manufacture of the EL element or color filter, making it possible to use the pressure absorbing apparatus in the manufacture of the EL element or color filter by employing the aforementioned corrosion-resistant material.

The ejector apparatus of the present invention is an ejector apparatus having a tank for feeding a liquid that has fluidity, and an ejecting head whereby the liquid fed from the tank is ejected onto an ejection object, characterized in that the pressure absorbing apparatus according to present invention is disposed between the tank and the ejecting head. Such an ejector apparatus has the above-described pressure absorbing apparatus and exhibits the same actions and effects. Specifically, droplets can be stably ejected from the ejecting head irrespective of the properties of the liquid.

In this situation, the ejecting head and the droplet outlet of the pressure absorbing apparatus are preferably linked via a rubber bushing, and at least the surface of the rubber bushing in contact with the liquid is preferably composed of a material that has corrosion resistance against the liquid. In this arrangement, the surface of the rubber bushing in contact with the liquid should be composed of a corrosion-resistant material. Consequently, the entire rubber bushing can be molded from the corrosion-resistant material, or a two-layer structure can be formed by coating a flexible rubber material such as silicone rubber with the corrosion-resistant material.

The corrosion resistance of the ejector apparatus can be improved by fashioning the rubber bushing that connects the pressure absorbing apparatus and the ejecting head from the corrosion-resistant material as well. Furthermore, the corrosion-resistant material is preferably at least one material selected from among fluororubber, fluororesin, elastomer, butyl rubber, and silicone rubber.

The rubber bushing is designed to fit tightly along the circumference of the droplet outlet or another component of the pressure absorbing apparatus and to prevent the liquid from leaking. For this reason, the rubber bushing preferably has sufficient flexibility to be able to deform in accordance with the shape of the droplet outlet when inserted into the droplet outlet of the pressure absorbing apparatus. In view of this, fluororubber, elastomer, butyl rubber, and silicone rubber are preferred when the entire rubber bushing is molded from a corrosion-resistant material. Examples of fluororubber include materials based on vinylidene fluoride (FKM), tetrafluoroethylene propylene (FEPM), and tetrafluoroethylene perfluorovinyl ether (FFKM). Among these, perfluororubber (including perfluoroelastomers), which is a type of fluororubber and has high corrosion resistance and heat resistance, is particularly preferred for such use. Also, fluororesin is particularly preferred because of the need to ensure a tight fit with the rubber material when the rubber bushing has a two-layer structure obtained by coating a rubber material with a corrosion-resistant material.

The electrooptical device of the present invention basically includes an electroluminescence element comprising a substrate provided with a plurality of electrodes, and a plurality of electroluminescence light emitting layers provided to the substrate in accordance with the electrodes. The electroluminescence light emitting layers are formed by ejecting a liquid containing a material for an EL layer onto the substrate from the ejector apparatus according to present invention. Alternatively, the electrooptical device has a color filter includes a substrate and a plurality of color filter layers of different colors formed on the substrate. The color filter layers are formed by ejecting a liquid containing color filter materials of specific colors onto the substrate from the ejector apparatus according to the present invention.

The EL element or color filter of the electrooptical device can be manufactured by the aforementioned ejector apparatus with high productivity, and the productivity of the electrooptical device can therefore be improved as well.

The device of the present invention has a base with an ejected pattern formed from the liquid being ejected onto the base from the ejector apparatus according to the present invention.

The ejector apparatus of the present invention is suitable for manufacturing a device that has a base in which a liquid that has fluidity is ejected onto the base, which is an ejection target. Device productivity can be improved because the liquid of the device is stably ejected by the aforementioned ejector apparatus.

The electronic apparatus of the present invention has the electrooptical device according to the present invention.

Possible examples of such electrooptical devices include personal computers and portable phones in which liquid-crystal panels and other display apparatuses are used as the above-described electrooptical device.

The presence of the above-described electrooptical device makes it possible to perform the same operation as with the electrooptical device.

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### Manufacturing Apparatus 1

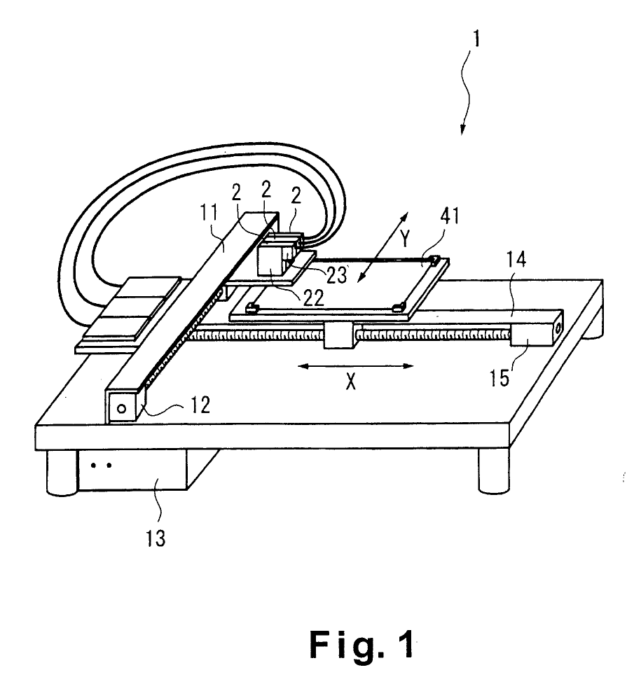

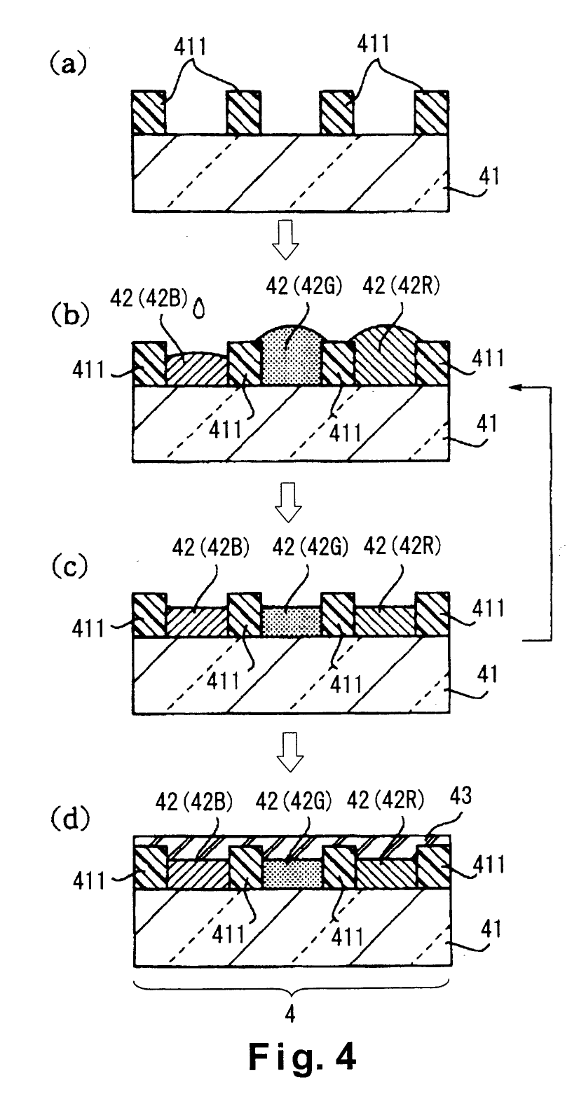

Referring initially to FIG. 1, a manufacturing apparatus 1 is illustrated that is used to manufacture a color filter 4 (FIG. 4) in accordance with a first embodiment of the present invention. The manufacturing apparatus 1 basically has three ejector apparatuses 2, a main scanning apparatus 11, a first drive motor 12, a control circuit 13, a substrate position controlling apparatus 14, and a second drive motor 15. These components of manufacturing apparatus 1 are conventional components that are well known in the art, except that the ejector apparatuses 2 have been modified as explained below. Since the components of manufacturing apparatus 1 are basically well known in the art, these structures will not be discussed or illustrated in detail herein.

The ejector apparatuses 2 are designed to eject a liquid (see FIG. 4) containing a color filter material onto a substrate 41 of the color filter 4. The three ejector apparatuses 2 each eject a liquid for red, a liquid for blue, or a liquid for green (ink). The three ejector apparatuses 2 are preferably ink jet printing apparatuses.

The main scanning apparatus 11 is designed to hold a pressure absorbing apparatus 23, such as pressure damper, and an ejecting head 22 of each of the ejector apparatuses 2, which are described below. The ejecting heads 22 can be ink-jet heads including a ink-jet head using a piezoelectric element, a ink-jet head using a electrostatic function, and a ink-jet head including a heater that generates an air bubble in a nozzle, and some types of dispenser including needle. Once a drive signal is supplied from the control circuit 13 to the drive motor 12, the main scanning apparatus 11 is driven, and the ejecting head 22 and the pressure absorbing apparatus 23 move in the direction of the Y-axis.

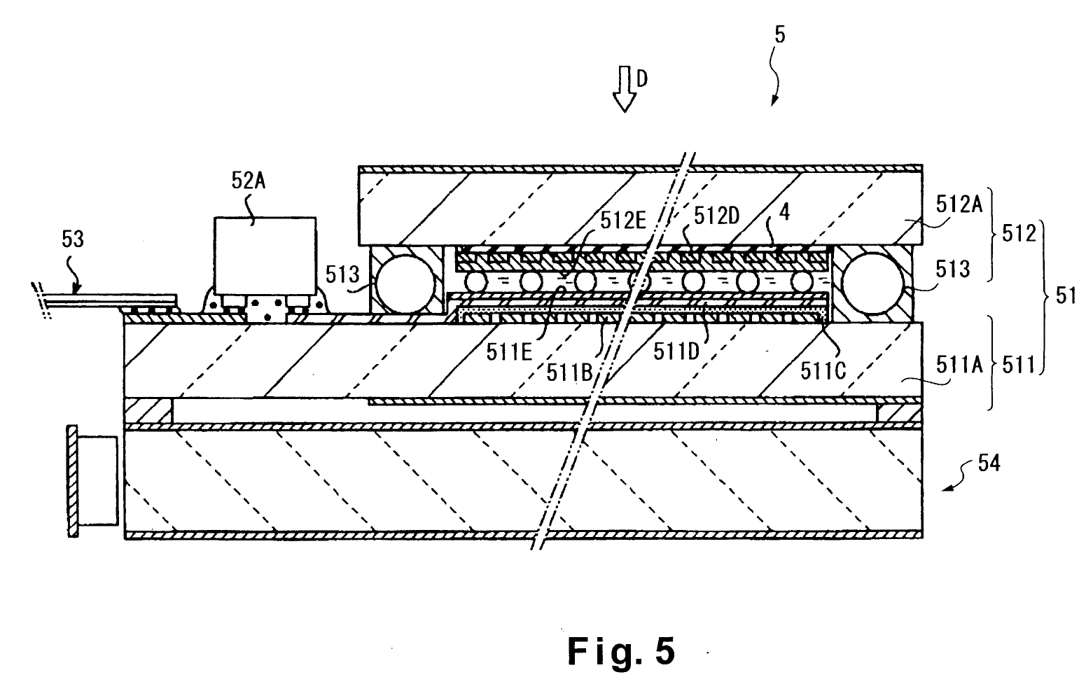

The substrate position controlling apparatus 14 is designed to hold the substrate 41 of the color filter 4 seen in FIG. 5. Once a drive signal is supplied from the control circuit 13 to the drive motor 15, the substrate position controlling apparatus 14 is driven, and the substrate 41 moves in the direction of the X-axis.

### Structure of the Ejector Apparatus 2

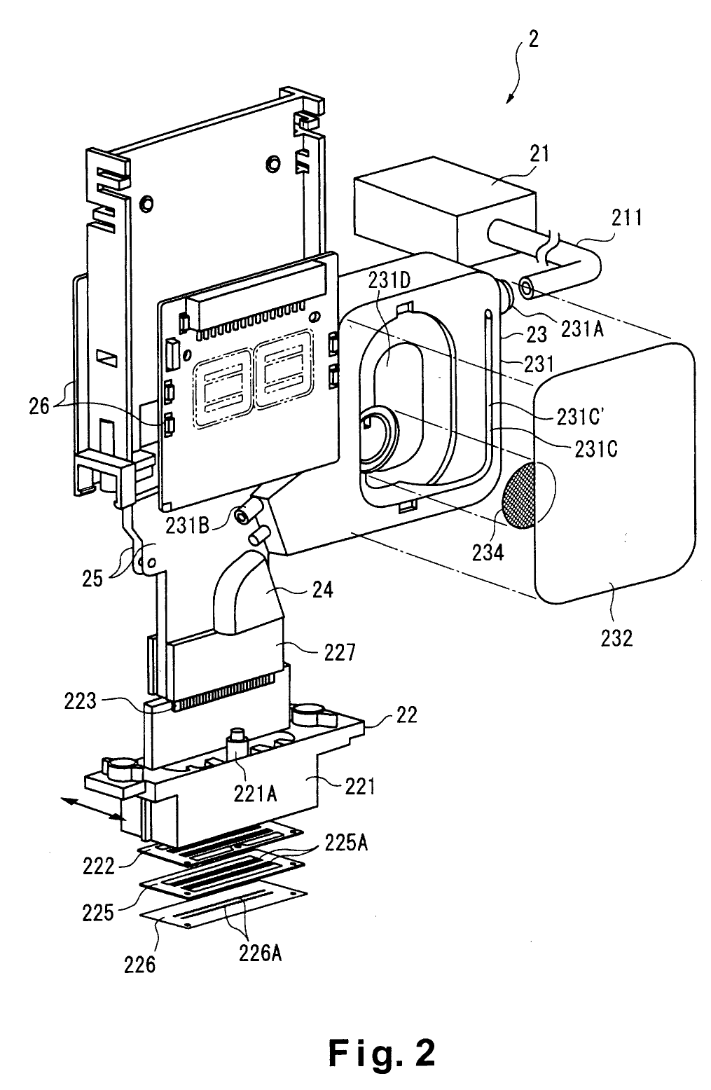

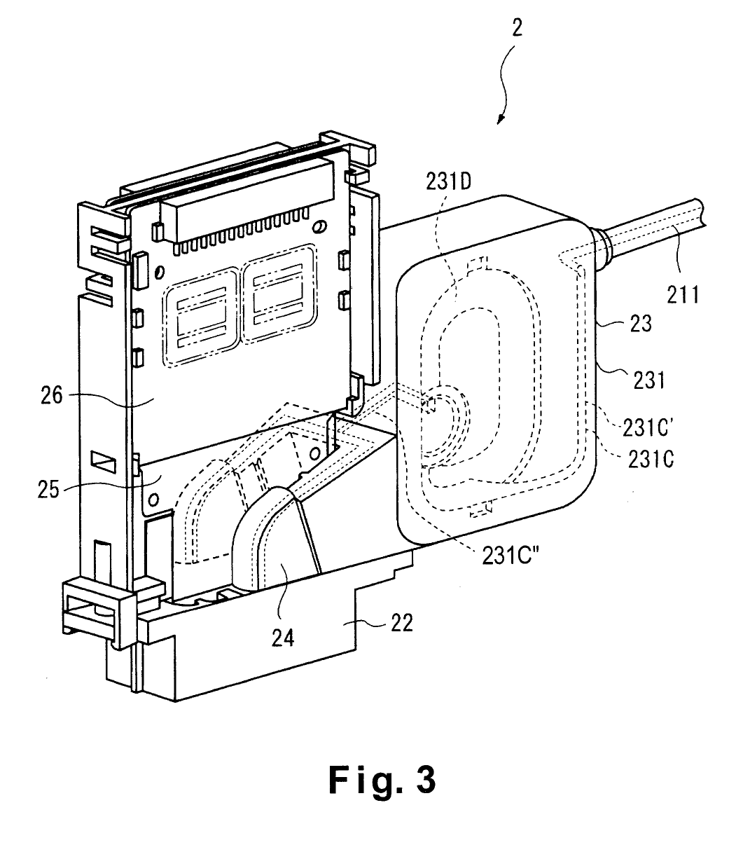

FIGS. 2 and 3 depict one of the ejector apparatuses 2 of the manufacturing apparatus 1. The ejector apparatus 2 has a tank or ink tank 21 for feeding an ink or liquid, and an ejecting head or ink jet head 22 for ejecting the liquid or ink fed from the tank 21. The pressure absorbing apparatus 23 is disposed between the tank 21 and the ejecting head 22.

The pressure absorbing apparatus 23 is designed to absorb the pressure fluctuations of the liquid fed to the ejecting head 22 from the tank 21. The pressure absorbing apparatus 23 is preferably a pressure damper that has a pressure absorbing apparatus main body 231, a film 232, and a filter 234.

The pressure absorbing apparatus main body 231 is provided with a droplet inlet 231A fluidly connected to the tank 21 via a tube 211, and a pair of droplet outlets 231B (only one shown in FIG. 2) fluidly connected to the ejecting head 22. In addition, the pressure absorbing apparatus main body 231 is provided with a groove-shaped passage 231C and a pressure absorbing portion 231D.

The droplet outlets 231B are fluidly connected in a corresponding fashion via a rubber bushing 24 to two identical feed tubes 221A (only one shown in FIG. 2) formed in the ejecting head 22.

The rubber bushing 24 is provided with an internal channel (shown in dashed lines in FIG. 3), and projections (not shown) are formed in the circumferential direction in the parts penetrated by the droplet outlets 231B or the feed tubes 221A. The projections of the rubber bushing 24 collapse upon fitting the droplet outlets 231B and the feed tubes 221A into the rubber bushing 24 to seal the circumference of the droplet outlets 231B and the feed tubes 221A. The rubber bushing 24 is preferably composed of a corrosion-resistant material that is corrosion resistance against the liquid or ink. Examples of suitable corrosion-resistant materials include perfluororubber, elastomer, butyl rubber, and silicone rubber.

The groove-shaped passage 231C fluidly connects the droplet inlet 231A and the droplet outlets 231B with the pressure absorbing portion 231D being located between the passage 231C and the droplet outlets 231B. The passage 231C includes a first passage portion 231C′ for guiding the liquid from the droplet inlet 231A to the pressure absorbing portion 231D, and a second passage 231C″ for guiding the liquid from the pressure absorbing portion 231D to the droplet outlets 231B. The second passage 231C″ is bifurcated, with each branch being fluidly connected to one of the droplet outlets 231B.

The filter 234 is attached by ultrasonic welding to the pressure absorbing apparatus main body 231 at the boundary between the pressure absorbing portion 231D and the second passage 231C″. The filter 234 is provided in order to prevent dust or bubbles from entering the second passage. The filter 234 can be formed from a resin that has corrosion resistance against the liquid, such as polypropylene, cyclic olefin copolymer, or polyethylene, or from SUS or the like.

The film 232 is thermally welded to the pressure absorbing apparatus main body 231 so that the passage 231C and the pressure absorbing portion 231D thereof are covered. The film 232 is preferably formed from a corrosion-resistant material that has corrosion resistance against the liquid, such as polypropylene, polyethylene, or a laminated film of polyethylene and nylon.

The droplet inlet 231A, the droplet outlets 231B, the passage 231C, and the pressure absorbing portion 231D of the pressure absorbing apparatus 23 are composed of a material that has corrosion resistance against the liquid or ink used in the applications disclosed herein. Examples of such corrosion-resistant materials include polypropylene, cyclic olefin copolymers, and polyethylene. In addition, the corrosion-resistant material can be formed from a single type of such resin, or a resin that is a mixture of two or more types.

The ink jet head or ejecting head 22 is provided with the feed tubes 221A, and has a head frame 221 to which the liquid or ink is fed, a diaphragm 222 mounted on the head frame 221, and an oscillator 223 fixed to the diaphragm 222.

The diaphragm 222 has a resin film (not shown) and a metal frame portion (not shown) attached to the resin film, and the frame portion is attached to the head frame 221. A spacer 225 having a pressure generating chamber 225A is disposed underneath the diaphragm 222. In addition, a nozzle plate 226 provided with a plurality of nozzles 226A for spraying the liquid in a jet configuration is disposed underneath the spacer 225.

The oscillator 223 is attached on one side to a vibration damping plate 227 bonded to the inner surface of the head frame 221. In addition, the electrodes of the oscillator 223 are connected to a pair of circuit substrates 26 via a pair of film substrates 25.

The liquid or ink is ejected in the following manner from the ejecting head 22. The oscillator 223 is contracted by applying a voltage of about 30 V from the circuit substrates 26 to the electrodes of the oscillator 223, and the diaphragm 222 vibrates with this contraction of the oscillator 223. Vibration of the ejecting head 222 causes the volume of the pressure generating chamber 225A formed in the ejecting head 222 to vary and pressure to be generated. The liquid is then ejected by this pressure from the nozzles 226A.

### Structure and Manufacture of the Color Filter 4

As seen in portion (d) of FIG. 4, the color filter 4 is illustrated that has been manufactured using the manufacturing apparatus 1 as described above. The color filter 4 basically has a square substrate 41, a color filter layer 42 and a protective film 43. The substrate 41 is formed from glass, plastic, or the like. The color filter layer 42 is obtained by applying or ejecting the liquid or ink in a dot pattern to the surface of the substrate 41. The protective film 43 is laminated over the color filter layer 42.

The method for manufacturing a color filter 4 will now be described with reference to FIG. 4. A substrate 41 (portion (a) of FIG. 4) provided with a plurality of partitions 411. The substrate 41 is held in advance in the substrate position controlling apparatus 14 of the manufacturing apparatus 1. The partitions 411 are formed from a non-translucent resin material and are arranged, for example, in a lattice pattern.

The drive motor 12 with the aid of the control circuit 13 drives the main scanning apparatus 11 to cause the ejecting head 22 with the pressure absorbing apparatus 23 to perform a reciprocating cycle across the substrate 41. In this situation, droplets of the liquid are fed or ejected between the partitions 411 from the ejecting head 22.

The substrate position controlling apparatus 14 is subsequently driven by the drive motor 15, and the substrate 41 moves a specific distance in the direction of the X-axis. The ejecting head 22 and the pressure absorbing apparatus 23 perform a reciprocating cycle across the substrate 41 when the main scanning apparatus 11 is driven again by the drive motor 12. The liquid is fed or ejected between all the partitions 411 by repeating these operations until a desired pattern is obtained such as seen in portion (b) of FIG. 4.

As seen in portion (b) of FIG. 4, a symbol 42R is used to indicate a liquid for a red (R) color, a symbol 42G is used to indicate a liquid for a green (G) color, and a symbol 42B is used to indicate a liquid for a blue (B) color.

When the spaces between the partitions 411 are filled with a specific amount of the liquid, the substrate 41 is heated by a heater (not shown) to vaporize the solvent of the liquid. The vaporization reduces the volume and smoothes the liquid, as shown in portion (c) of FIG. 4. If the reduction in volume is considerable, the feeding of the liquid and the heating and vaporization are performed repeatedly until an adequate film thickness is obtained for the color filter 4. The above procedure causes the solids of the liquid to ultimately remain and to form a film, thereby completing the color filter layer 42.

After the color filter layer 42 has been formed by the above operation, a heat treatment is conducted at a specific temperature for a specific time in order to completely dry the color filter layer 42. The protective film 43 for protecting the color filter layer 42 is then formed. The protective film 43 can be formed using the manufacturing apparatus 1, and the film forming method can, for example, be a technique such as spin coating, roll coating, or dipping.

### Structure of the Liquid Crystal Apparatus 5

The color filter 4 as manufactured according to the present invention can be used in a liquid crystal apparatus 5, which is an electrooptical device such as the one shown in FIG. 5. In the liquid crystal apparatus 5, an integrated circuit (IC) 52A for driving liquid crystals and an integrated circuit (not shown) for driving liquid crystals are mounted as semiconductor chips on a liquid crystal panel 51. A flexible printed circuit (FPC) 53 is connected as a wiring connection element to a liquid crystal panel 51. Another feature of the liquid crystal apparatus 5 is a lighting apparatus 54 that is formed as a backlight on the reverse side of the liquid crystal panel 51. The liquid crystal panel 51 is preferably formed by pasting a first substrate 511 and a second substrate 512 together using a sealing element 513.

The first substrate 511 has a planar base 511A, a reflecting film 511B, an insulating film 511C, a first electrode 511D and an orienting film 511E. The planar base 511A is formed from transparent glass, transparent plastic, or the like. The reflecting film 511B is formed on the internal surface (top surface in FIG. 5) of the base 511A. The insulating film 511C is laminated onto the reflecting film 511B. The first electrode 511D is formed on the insulating film 51 IC. The orienting film 511E is further formed on the first electrode 511D.

The second substrate 512 has a planar base 512A, which is formed from transparent glass, transparent plastic, or the like, with the color filter 4 being provided to the internal surface (bottom surface in FIG. 5) of the base 512A. The second substrate 512 also has a second electrode 512D is formed on the color filter 4, with an orienting film 512E being further formed on the second electrode 512D.

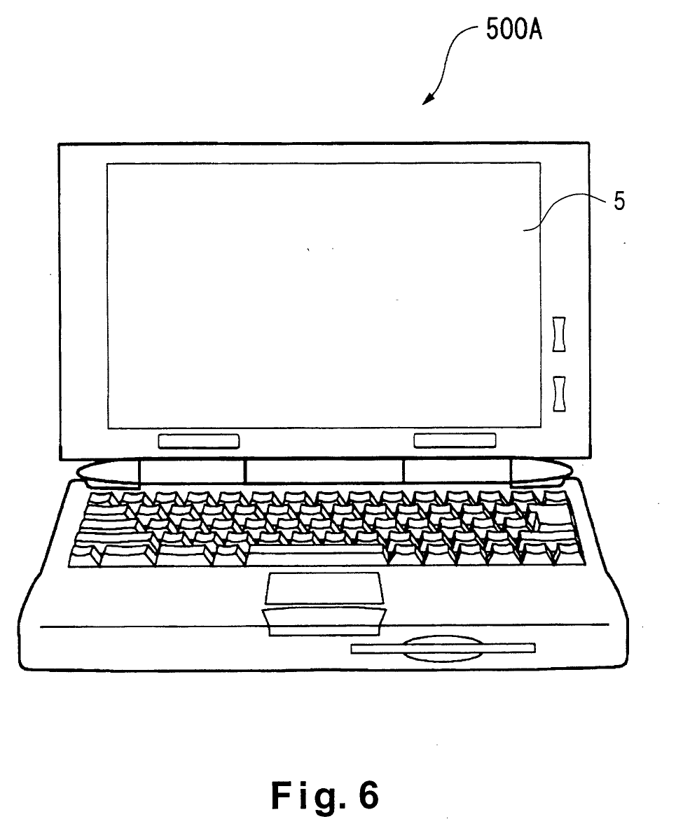

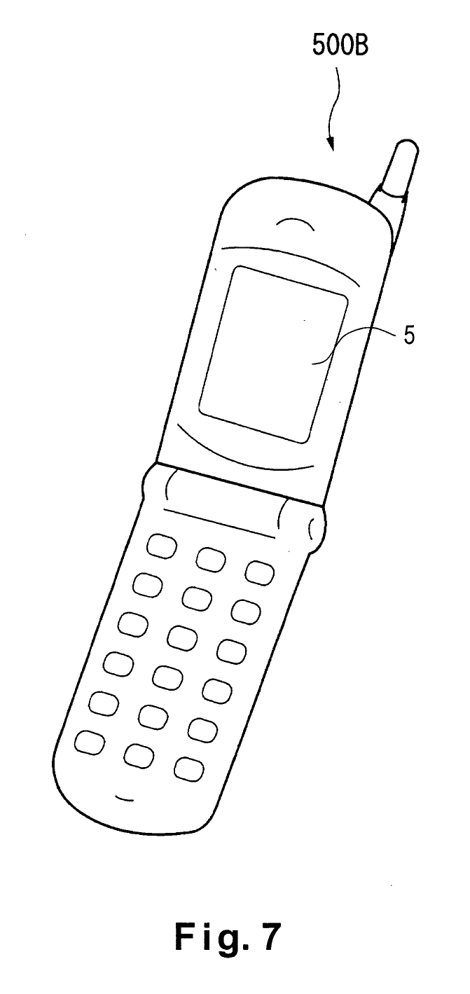

The liquid crystal apparatus 5 can be incorporated into a personal computer 500A such as the one shown in FIG. 6, a portable phone 500B such as the one shown in FIG. 7, or any other electronic apparatus.

Consequently, the following effects can be obtained in accordance with the present embodiment.

(1) At the surface of the droplet inlet 231A, the droplet outlets 231B, the passage 231C, and the pressure absorbing portion 231D of the pressure absorbing apparatus 23 that are exposed or contact the liquid are composed of a corrosion-resistant material, making it possible to prevent the pressure absorbing apparatus 23 from being damaged by the corrosion of the surface in contact with the liquid or ink. In addition, pressure fluctuations of the liquid are absorbed by the pressure absorbing apparatus 23, making it possible to eject droplets from the ejecting head 22 in a stable manner. Consequently, it is possible to reduce the percent defective of the color filter 4 and to improve the production efficiency of the color filter 4.

(2) Polyethylene, polypropylene, or cyclic olefin copolymer is preferably used as the corrosion-resistant material for the pressure absorbing apparatus 23. Since these resins have particularly high resistance against the liquid of the color filter 4, it is possible to prevent damage to the pressure absorbing apparatus 23 with even greater efficiency.

(3) In addition, the entire droplet inlet 231A, the droplet outlets 231B, passage 231C, and the pressure absorbing portion 231D are preferably composed of a corrosion-resistant material, which dispenses with the need to expend as much labor on manufacturing the pressure absorbing apparatus 23 as when the corrosion-resistant material is applied solely to the surfaces or areas in contact with the liquid.

(4) The rubber bushing 24 for connecting the pressure absorbing apparatus 23 and the ejecting head 22 is composed of a corrosion-resistant material that has corrosion resistance against the liquid. It is therefore possible to make the ejector apparatus 2 into a construction with higher corrosion resistance.

(5) In addition, the corrosion-resistant material of the rubber bushing 24 is a perfluororubber, elastomer, butyl rubber, or silicone rubber, and has not only corrosion resistance but also flexibility. Consequently, any formed projections can be collapsed and the droplet outlets 231B or the like can be sealed when the droplet outlets 231B or the like are inserted into the rubber bushing 24, making it possible to securely prevent the liquid from leaking.

(6) In addition, the filter 234 attached to the boundary between the pressure absorbing portion 231D and the second passage 231C″ is formed from a resin that has corrosion resistance against the liquid, such as polypropylene, cyclic olefin copolymer, or polyethylene, or from SUS or the like, making it possible to further improve the corrosion resistance of the pressure absorbing apparatus 23.

(7) In addition, the color filter 4 of the liquid crystal apparatus 5 can be manufactured with high production efficiency by using the above-described ejector apparatus 2, making it possible to improve productivity for the liquid crystal apparatus 5 as well as for the personal computer 500A (FIG. 6), the portable phone 500B (FIG. 7), or any other electronic apparatus that incorporates this liquid crystal apparatus 5 of the present invention.

### Structure of the Light Emitting Apparatus 7

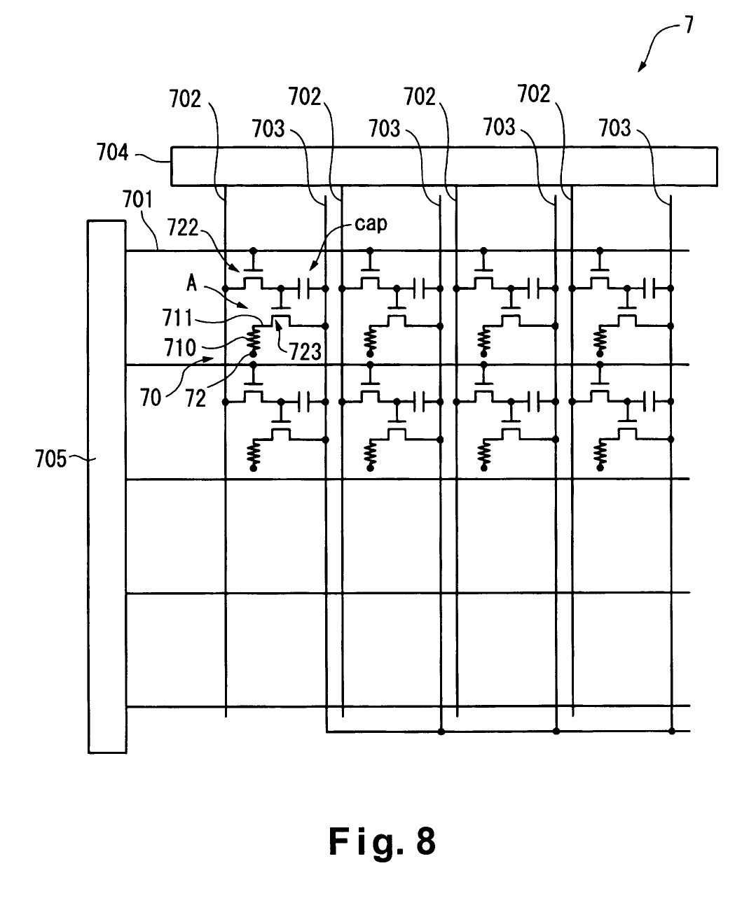

Referring now to FIGS. 8-11, an electrooptical device in accordance with a second embodiment will now be explained that incorporates a light emitting apparatus 7 which is manufactured with the aid of the ejector apparatus 2, which was previously discussed.

The light emitting apparatus 7, which is the electrooptical device, is obtained by the wiring of a plurality of scan lines 701, a plurality of signal lines 702 extending in a direction that intersects the scan lines 701, and a plurality of power supply lines 703 that extend parallel to the signal lines 702, as shown in FIG. 8.

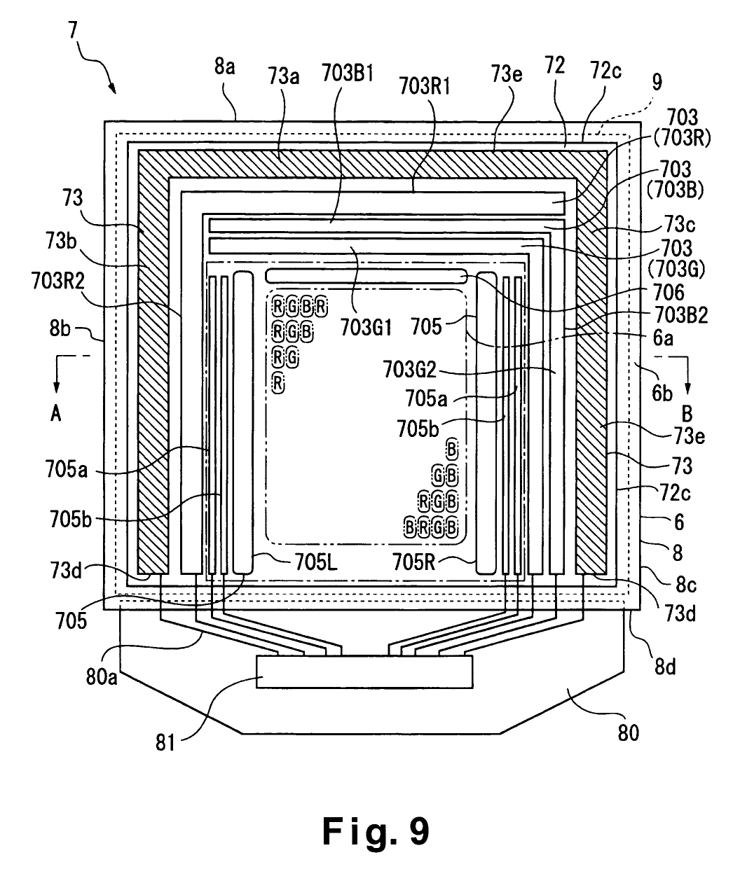

As shown in FIGS. 9 to 11, in the light emitting apparatus 7, a display element 70 is formed on a substrate 8, and a sealing portion 9 is formed thereon. The substrate 8 is configured by forming a circuit element portion 74 on a transparent substrate 6 composed of glass or the like.

Pixel regions A are formed at the points of intersection of the scan lines 701 and signal lines 702. The signal lines 702 are connected to a data-side drive circuit 704 comprising shift registers, level shifters, video lines, and analog switches. The scan lines 701 are connected to a scan-side drive circuit 705 comprising shift registers and level shifters. Each pixel region A includes a thin-film switching transistor 722, a storage capacitor cap, a thin-film drive transistor 723 and an organic EL element (display element) 70. The thin-film switching transistor 722 has a gate electrode that receives a scan signal via the scan line 701. The storage capacitor cap is configured to hold a pixel signal shared from the signal lines 702 via the thin-film switching transistor 722. The thin-film drive transistor 723 has a gate electrode that receives the pixel signal held by the storage capacitor cap. When an electrical connection is established with the power supply lines 703 via the thin-film drive transistor 723, the organic EL element (display element) 70 receives a drive current from the power supply lines 703.

The light emitting apparatus 7 is configured such that when the scan line 701 is driven and the thin-film switching transistor 722 is switched on, the corresponding potential of the signal line 702 is held by the storage capacitor cap, and the on/off state of the thin-film drive transistor 723 is determined in accordance with the state in the storage capacitor cap.

The light emitting apparatus 7 is also configured such that when the drive current flows from one of the power supply lines 703 to a pixel electrode 711 via the channel of the thin-film drive transistor 723, this current flows to a cathode 72 via a functional layer 710, and the functional layer 710 emits light in accordance with the value of the current.

As shown in FIGS. 9 to 11, in the light emitting apparatus 7, the display element 70 is formed on the substrate 8, and the sealing portion 9 is formed on the display element 70. The substrate 8 is configured by forming the circuit element portion 74 on the transparent substrate 6 which is composed of glass or the like.

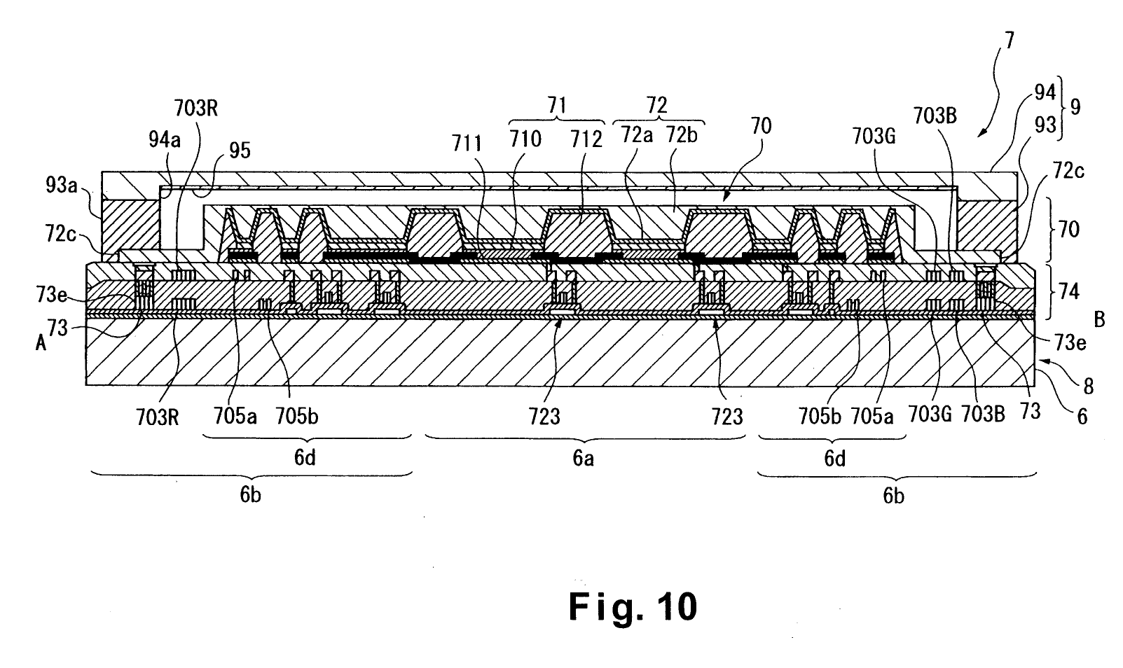

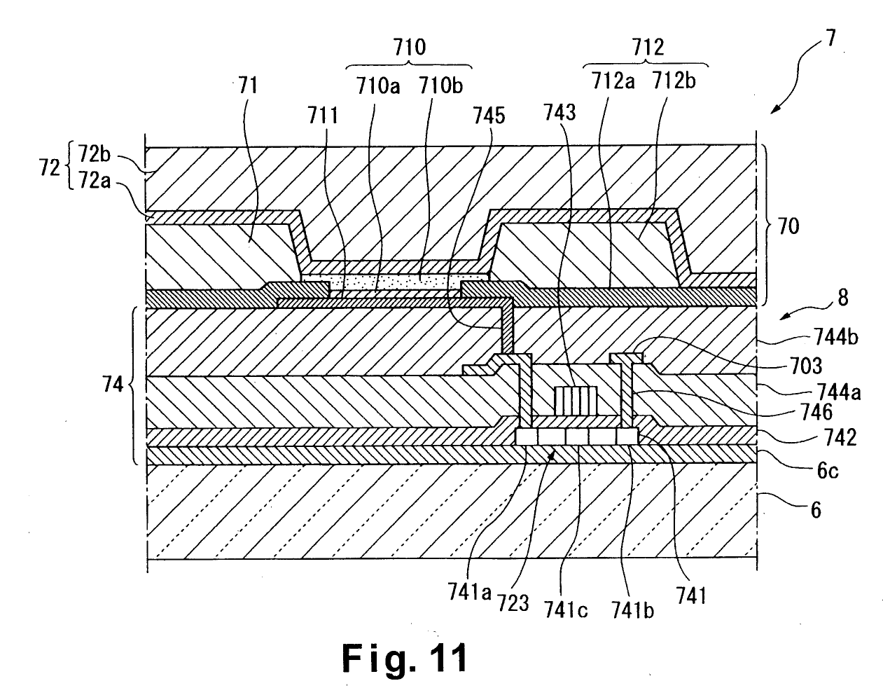

The circuit element portion 74 includes a base protective film 6c composed of silicon oxide is formed on the substrate 6, and an island-shaped semiconductor film 741 composed of polycrystalline silicon is formed on the base protective film 6c, as shown in FIGS. 10 and 11.

The thin-film transistor 723 is formed in the circuit element portion 74. The semiconductor film 741 has a source region 741a and a drain region 741b. The source region 741a and the drain region 741b are formed by an ion implantation of high-concentration P in the semiconductor film 741. The part that does not have any P introduced thereto serves as a channel region 741c.

A transparent gate insulating film 742 for covering the base protective film 6c and the semiconductor film 741 is formed in the circuit element portion 74. A gate electrode 743 (scanning line 701) comprising Al, Mo, Ta, Ti, W, or the like is formed on the gate insulating film 742. A first transparent interlayer insulating film 744a and a second transparent interlayer insulating film 744b are formed on the gate electrode 743 and the gate insulating film 742. The gate electrode 743 is disposed at a position that corresponds to the channel region 741c of the semiconductor film 741.

Contact holes 745 and 746, which are respectively connected to the source and drain regions 741a and 741b of the semiconductor film 741, are formed in the first and second interlayer insulating films 744a and 744b, as shown in FIG. 11.

The contact hole 745 formed in second interlayer insulating film 744b is connected to a pixel electrode 711 formed on the second interlayer insulating film 744b. The contact hole 746 formed in the first interlayer insulating film 744a is connected to the power supply lines 703.

Control signal lines 705a for drive circuits and power supply lines 705b for drive circuits, which are connected to the scan-side drive circuits 705 are disposed in the circuit element portion 74, as shown in FIGS. 9 and 10.

The above-described storage capacitor cap and thin-film switching transistor 722 are formed in the circuit element portion 74.

The display element 70 includes the plurality of pixel electrodes 711, a plurality of light emitting element portions 71 provided thereon, and the cathodes 72 (counter electrodes) provided thereon. The pixel electrodes 711 are formed, for example, from transparent indium-tin oxide (ITO) and patterned into a rough rectangle when viewed in a plane, as shown in FIGS. 10 and 11. The thickness of the pixel electrodes 711 is preferably within a range of 50 to 200 nm, and more particularly about 150 nm.

The light emitting element portions 71 primarily comprise a plurality of functional layers 710 formed on the pixel electrodes 711, with a plurality of bank portions 712 for partitioning these functional layers 710.

The functional layers 710 comprise a hole injection/transport layer 710a laminated to the pixel electrodes 711, and a light emitting layer 710b (EL light emitting layer) proximally formed on the hole injection/transport layer 710a, as shown in FIG. 11.

The hole injection/transport layer 710a serves to improve the luminous efficiency, service life, and other element characteristics of the light emitting layer 710b. The hole injection/transport layer 710a has the function of injecting holes into the light emitting layer 710b. Also hole injection/transport layer 710a has the function of transporting the holes through the hole injection/transport layer 710a. A mixture of, for example, polyethylene dioxythiophene or another thiophene derivative with polystyrenesulfonic acid can be used as the material for the hole injection/transport layer 710a. The hole injection/transport layer 710a is formed by coating the pixel electrodes 711 with a liquid containing the material of the hole injection/transport layer 710a or a precursor thereof. Specifically, in applying the liquid to the pixel electrodes 711, the main scanning apparatus 11 and the substrate position controlling apparatus 14 are driven in the same manner as discussed above in the manufacture of the color filter 4.

In the embodiment described herein, it was assumed that polypropylene or the like was the corrosion-resistant material used in the pressure absorbing portion 231D and other components of the pressure absorbing apparatus 23, but a cyclic olefin copolymer, polyparaphenylene benzoxazole, polyoxymethylene, polypropylene, or the like can also be used when the hole injection/transport layer 710a is molded. These resins, SUS, or the like can also be used for the filter 234 as well. Furthermore, perfluororubber, elastomer, butyl rubber, and silicone rubber can, for example, be used for the rubber bushing 24 in the same manner as in the above-described embodiment.

The light emitting layer 710b is configured such that holes injected from the hole injection/transport layer 710a recombine with electrons injected through the cathode 72, and light is emitted.

The light emitting layer 710b includes a red-color light emitting layer R, a green-color light emitting layer G, and a blue-color light emitting layer B, as shown in FIG. 9. An organic light-emitting material such as a tris(8-quinolinol)aluminum complex (Alq) or the like can be used as the material for the light emitting layer 710b. In this case as well, the light emitting layer 710b can be formed by ejecting a liquid containing an organic light emitting material or a precursor thereof from the ejecting head 22 of the ejector apparatus 2. In this situation, the corrosion-resistant material used for the pressure absorbing portion 231D and other components of the pressure absorbing apparatus 23 is preferably a fluororesin, polyoxyethylene, or polypropylene. These resins, SUS, or the like can also be used for the filter 234 as well. Furthermore, for the rubber bushing 24 it is preferable to use, for example, fluororubber, of which perfluororubber (including perfluoroelastomers) is particularly preferred for this use.

The bank portions 712 are obtained by laminating an inorganic bank layer 712a (first bank layer) disposed on the side of the substrate 8, and an organic bank layer 712b (second bank layer) disposed at a distance from the substrate 8. Part of the inorganic bank layer 712a and part of the organic bank layer 712b are formed along the peripheral portions of the pixel electrodes 711. Specifically, the inorganic bank layer 712a is formed so as to be superposed in a planar fashion in the peripheral portions of the pixel electrodes 711. The organic bank layer 712b is formed in the same manner at planarly superposed positions in the peripheral portions of the pixel electrodes 711.

The inorganic bank layer 712a is formed so as to reach the center side of the pixel electrodes 711 beyond the organic bank layer 712b. The inorganic bank layer 712a preferably includes, for example, SiO₂, TiO₂, or another inorganic material. The thickness of the inorganic bank layer 712a is preferably within a range of 50 to 200 nm, and particularly about 150 nm.

The organic bank layer 712b can be formed from a material that has heat resistance and solvent resistance, such as an acrylic resin or polyimide resin. The thickness of the organic bank layer 712b is preferably within a range of 0.1 to 3.5 μm, and particularly about 2 μm.

The cathode 72 is fashioned into a rectangle, and is shaped so as to cover the entire surface of the light emitting element portions 71, as shown in FIGS. 9 and 10. The cathode 72 can be formed by laminating, for example, a first layer 72a composed of calcium or the like, and a second layer 72b composed of aluminum or the like.

The second layer 72b is designed to reflect light generated from the light emitting layer 710b toward the substrate 6, and is formed using Al or Ag. The second layer 72b can also be a laminated film comprising Al layers and Ag layers.

A protective layer can also be formed on the second layer 72b to prevent oxidation and composed of SiO, SiO₂, SiN, or the like.

The cathode 72 can be formed by CVD, sputtering, vapor deposition through a mechanical mask, or the like.

The substrate 8 is fashioned into a rough rectangle, and is partitioned into a plurality of rectangular display regions 6a disposed on the inside (substrate center side), and a plurality of non-display regions 6b disposed on the outside (substrate periphery side) of the display regions 6a, as shown in FIGS. 9 and 10.

Symbol 6d designates dummy display regions formed in the non-display regions 6b at positions that are adjacent to the display regions 6a.

In the description that follows, “top” and “bottom” indicate the top and bottom sides in FIG. 9, and “right” and “left” indicate the right-hand and left-hand sides in FIG. 9.

A flexible substrate 80 is attached to the bottom side 8d of the substrate 8, and a drive IC 81 is mounted on the flexible substrate 80

The display regions 6a are regions in which the light emitting element portions 71 are arranged in a matrix, and are also called effective display regions.

In the non-display regions 6b, the scan-side drive circuits 705 (scan-side drive circuits 705R and 705L) are provided to the circuit element portion 74 at positions that correspond to the right-hand and left-hand sides in the display regions 6a.

The control signal lines 705a for drive circuits and the power supply lines 705b for drive circuits connected to the scan-side drive circuits 705R and 705L are disposed within the circuit element portion 74 at positions that correspond to the right-hand side of the scan-side drive circuits 705R on the right, and to the left-hand side of the scan-side drive circuits 705 L on the left.

A testing circuit 706 is provided above the display regions 6a to allow the light emitting apparatus to be tested for quality or defects during manufacturing or at the time of shipping.

The first power supply line 703G connected to the light emitting layer 710b for emitting green light is formed in the circuit element portion 74 at a position that corresponds to the top side of the testing circuit 706 and to right-hand side of the control signal line 705a for drive circuits on the right.

The first power supply line 703G is fashioned into an L-shape that includes a first part 703G1 extending to the left and right on the top side of the testing circuit 706, and a second part 703G2 extending up and down on the right-hand side of the control signal line 705a for the drive circuits.

The second power supply line 703B connected to the light emitting layer 710b for emitting blue light is formed in the circuit element portion 74 at a position that corresponds to the top side of the first part 703G1 of the power supply line 703G and to the right-hand side of the second part 703G2.

The second power supply line 703B is fashioned into an L-shape that includes a first part 703B1 extending to the left and right on the top side of the first part 703G1, and a second part 703B2 extending up and down on the right-hand side of the second part 703G2.

The third power supply line 703R connected to the light emitting layer 710b for emitting red light is formed in the circuit element portion 14 at a position that corresponds to the top side of the first part 703B1 of the power supply line 703B and to the left-hand side of the control signal line 705a for the drive circuits on the left.

The third power supply line 703R is fashioned into an L-shape that includes a first part 703R1 extending to the left and right on the top side of the first part 703B1, and a second part 703R2 extending up and down on the left-hand side of the control signal line 705a for the drive circuits.

Cathode (wiring for the counter electrode) wiring 73 connected to the cathode 72 is formed outside (substrate periphery side) of the power supply line 703.

The cathode wiring 73 is fashioned into a horseshoe configuration that includes a first part 73a, a second part 73b, and a third part 73c. The first part 73a is formed above the first part 703R1 of the third power supply line 703R. The second part 73b is formed on the left-hand side of the second part 703R2 of the power supply line 703R. The third part 73c is formed on the right-hand side of the second part 703B2 of the second power supply line 703B.

The first part 73a in the light emitting apparatus 7 is formed so as to extend to the right and left along the top face 8a above the rectangular substrate 8. One end portion and the other end portion of the first part 73a extend in the vicinity of one end portion of the top face 8a and the vicinity of the other end portion of the top face 8a, respectively.

The second part 73b is shaped so as to extend up and down along the left face 8b in the left-hand portion of the rectangular substrate 8. One end portion and the other end portion of the second part 73b extends in the vicinity of one end portion of the left face 8b and the vicinity of the other end portion of the left face 8b, respectively.

The third part 73c is formed so as to extend up and down along the right face 8c in the left-hand portion the rectangular substrate 8. One end portion and the other end portion of the third part 73c extends in the vicinity of one end portion of the top side 8c and the vicinity of the other end portion of the top side 8c, respectively.

The cathode wiring 73 is preferably provided inwardly (toward the substrate center) from the periphery 72c of the cathode 72. Specifically, the cathode wiring 73 is preferably shaped in a manner such that the periphery 73e (top edge of the first part 73a, left edge of the second part 73b, and right edge of the third part 73c) is closer to the substrate center away from the periphery 72c of the cathode 72.

The distance between the periphery 73e of the cathode wiring 73 and the periphery 72c of the cathode 72 should be 1 mm or greater (preferably 2 mm or greater). If the distance is below this range, there is a danger that the contact area between the cathode 72 and the cathode wiring 73 will decrease and the electrical resistance therebetween will increase when the formation position of the cathode 72 is shifted. The width of the cathode wiring 73 is preferably set to be equal to or greater than the width of the power supply lines 703 (total width of the first to third power supply lines 703G, 703B, and 703R). Keeping the width of the cathode wiring 73 below this range is unsuitable because the current flowing through the functional layers 710 will tend to decrease in this case.

The lower end portions 73d, 73d of the cathode wiring 73 (lower end portions of the second and third parts 73b and 73c) are connected to the drive IC 81 (drive circuit) on the flexible substrate 80 via a connecting wiring 80a. The cathode wiring 73 can be configured by laminating a plurality of wiring layers. Examples of materials for such wiring layers include Al, Mo, Ta, Ti, W, Cu, TiN, and alloys thereof. The cathode wiring 73 can be formed from at least either one of the material for forming the scan lines 701 and the material for forming the signal lines 702. Examples of such materials include Al, Mo, Ta, Ti, W, Cu, TiN, and alloys thereof.

The display region 6a, the scan-side drive circuit 705, the control signal line 705a for the drive circuit, the power supply line 705b for the drive circuit, the testing circuit 706, the power supply lines 703, and the cathode wiring 73 are formed inwardly (toward the substrate center) from the periphery 72c of the cathode 72.

Specifically, the display region 6a, the scan-side drive circuit 705, the control signal line 705a for the drive circuit, the power supply line 705b for the drive circuit, the testing circuit 706, the power supply lines 703, and the cathode wiring 73 are formed so as to cover the cathode 72.

The sealing portion 9, which is designed to prevent the cathode 72 and the light emitting element portions 71 from being oxidized by the water, oxygen, and the like in the outside air, includes a seal substrate 94 and a sealing resin 93 for bonding the seal substrate 94 to the substrate 8, as shown in FIG. 10. The seal substrate 94 is composed of glass, metal, synthetic resin, or the like, and is provided with a concavity 94a for accommodating the display element 70 on the bottom side thereof. The concavity 94a is preferably provided with a getter layer 95 for absorbing water, oxygen, and the like. The can seal substrate 94 is joined to the substrate 8 by the sealing resin 93 along the peripheral portion thereof. The sealing resin 93 is composed of a thermosetting resin, UV-curing resin, or the like, and is particularly preferably composed of epoxy resin, which is a type of thermosetting resin.

The sealing portion 9 is preferably shaped so as to cover the cathode 72. Specifically, the periphery 93a of the sealing resin 93 is preferably shaped so as to be disposed outwardly (toward the substrate periphery) from the periphery 72c of the cathode 72.

When a drive current flows from one of the power supply lines 703 to one of the pixel electrode 711 via the channel of the thin-film drive transistor 723 in the light emitting apparatus 7, this current flows through the cathode wiring 73 via the functional layer 710 and the cathode 72, and the functional layer 710 emits light in accordance with the value of the current.

The light generated by the functional layer 710 toward the substrate 6 is transmitted by the circuit element portion 74 and the substrate 6, and is emitted toward the observer. The light emitted by the functional layer 710 toward the cathode 72 is reflected by the cathode 72, transmitted by the circuit element portion 74 and the substrate 6, and emitted toward the observer. Light can also be emitted from the cathode side by using a transparent material for the cathode 72. For example, ITO, Pt, Ir, Ni, or Pd can be used as the transparent material.

The present invention is not limited by the above-described embodiments and includes any modifications, improvements, or other changes made within the scope in which the objects of the present invention can be attained.

For example, the manufacturing apparatus 1 was used in the above-described embodiments to manufacture the color filter 4 or the display element 70, but possible applications are not limited by these types of manufacture. For example, other applications include: arrangements in which liquid metals, electroconductive materials, metal-containing pigments (or precursors thereof), or the like are ejected to obtain metal wiring or the like in order to form the electrical wiring of a printed circuit board; arrangements in which an optical member is formed by employing ejection to form minute micro-lenses on a base; arrangements in which a resist applied to a substrate is ejected so as to cover the necessary parts alone; arrangements in which light-scattering convexities, minute white patterns, or the like are formed by ejection on plastic or other translucent substrates or the like to form a light-scattering plate; arrangements in which a liquid crystal material used for a liquid crystal panel is applied to a base; arrangements in which oriented films for liquid crystal panels are formed by ejection; and arrangements in which RNA (ribonucleic acid) is ejected as spike spots that form a matrix on a DNA (deoxyribonucleic acid) chip to fabricate a fluorescent indicator probe and to perform hybridization on the DNA chip, or in which a sample, antibody, DNA (deoxyribonucleic acid), or the like is otherwise ejected at positions in a dot configuration partitioned on a base to form a biochip, as in chemical testing apparatuses or the like.

In the embodiments described above, it was assumed that the electrooptical device was incorporated into the personal computer 500A or the portable phone 500B, but it is also possible to incorporate this apparatus into an electronic organizer, pager, POS (point of sale) terminal, IC card, minidisk player, liquid crystal projector, engineering workstation (EWS), word processor, television, video tape recorder with a viewfinder or direct-view monitor, desktop computer, car navigation system, apparatus equipped with a touch panel, watch, gaming instrument, or other electronic apparatus.

In the embodiments described above, the pressure absorbing apparatus 23 was incorporated into the ejector apparatus 2 in which droplets were ejected based on electrical signals such as those shown in FIG. 2, but this option is nonlimiting, and the pressure absorbing apparatus 23 can also be incorporated into an ejector apparatus in which droplets are ejected by pneumatic pressure.

In the embodiments described above, it was assumed that the entire pressure absorbing portion 231D or the like was made of a corrosion-resistant material, but the present invention can be implemented in any other manner as long as at least the surface in contact with the liquid is made of a corrosion-resistant material. It is therefore possible to form the pressure absorbing portion 231D or the like from a resin that does not have corrosion resistance, and to coat solely the surface in contact with the liquid with the above-described corrosion-resistant material. Adopting this approach makes it possible to reduce the amount in which the corrosion-resistant material is used, and hence to reduce manufacturing costs.

In addition, polyethylene, polypropylene, fluororesin, polyoxymethylene, cyclic olefin copolymer, polyparaphenylene benzoxazole, and the like were cited as corrosion-resistant materials in connection with the above-described embodiments, but these materials are non-limiting. Specifically, any material can be used as long as this material has corrosion resistance against the liquid. It is possible, for example, to make an appropriate selection in accordance with the type of liquid, as shown in Table 1. In Table 1, the circles ◯ indicate “excellent”; the triangles Δ indicate “good”; the cross-outs x indicate “poor.”

TABLE 1

| | LIQUID MATERIAL | | | |
|---|---|---|---|---|
| | | Liquid | Liquid | |
| | Liquid | Material | Material | |
| | Material | for | for | Liquid |
| | for | Liquid | Oriented | Material |
| | Overcoat | crystal | film | for Resist |
| CORROSION- | | | | |
| RESISTANT | | | | |
| MATERIAL | | | | |
| COC | ◯ | ◯ | ◯ | X |
| PBO | X | ◯ | ◯ | ◯ |
| POM | ◯ | ◯ | ◯ | ◯ |
| PE | X | Δ-X | ◯-Δ | ◯-Δ |
| PP | ◯ | ◯ | ◯ | ◯ |

In the rubber bushing 24 provided to the ejector apparatus 2, the rubber bushing 24 as such comprised a fluororubber, elastomer, butyl rubber, or silicone rubber, but the rubber bushing 24 can also have a two-layer structure formed by applying a corrosion-resistant material to silicone rubber or another rubber material that has flexibility. When a two-layer structure is used, a fluororesin is preferably coated as the corrosion-resistant material because of the need to ensure adhesion to the rubber material.

In addition, the corrosion-resistant material is not limited to those listed, and it is sufficient to make an appropriate selection in accordance with the type of liquid, as shown, for example, in Table 2. In Table 2, the circles ◯ indicate “excellent”; the triangles Δ indicate “good”; the cross-outs x indicate “poor.”

TABLE 2

| | LIQUID MATERIAL | | | |
|---|---|---|---|---|
| | | Liquid | Liquid | |
| | Liquid | Material | Material | |
| | Material | for | for | Liquid |
| | for | Liquid | Oriented | Material |
| | Overcoat | Crystal | Film | for Resist |
| CORROSION- | | | | |
| RESISTANT | | | | |
| MATERIAL | | | | |
| Perfluororubber | ◯ | ◯ | ◯ | ◯ |
| Silicone rubber | Δ | ◯ | ◯ | ◯ |
| Butyl rubber | Δ-X | Δ | ◯ | X |
| Elastomer | ◯ | X | X | X |

The surface of the rubber bushing 24 in contact with the liquid can also comprise a corrosion-resistant material. This is because in the present invention the surfaces of the droplet inlet 231A, the droplet outlets 231B, the passage 231C, and the pressure absorbing portion 231D of the pressure absorbing apparatus 23 in contact with the liquid should be made of a corrosion-resistant material.

According to the present invention, an effect is achieved whereby it is possible to provide a pressure absorbing apparatus capable of ejecting droplets from the ejecting head in a stable manner irrespective of the properties of the liquid. This pressure absorbing apparatus is used in an ejector apparatus, that can be used to manufacture an electrooptical device having a color filter or an EL element, and that can be used to manufacture an electronic apparatus with this electrooptical device. A device having a base is manufactured with an ejected pattern that is formed by using the ejector apparatus.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

This application claims priority to Japanese Patent Application No. 2002-196460. The entire disclosure of Japanese Patent Application No. 2002-196460 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A pressure absorbing apparatus to be disposed between a tank for a liquid and an ejecting head that ejects the liquid from the tank onto an ejection object, the pressure absorbing apparatus comprising:
a droplet inlet configured to be fluidly connected to the tank;
a droplet outlet configured to be fluidly connected to the ejecting head;
a channel fluidly connecting the droplet inlet to the droplet outlet; and
a pressure absorbing portion in communication with the channel;
the pressure absorbing apparatus absorbing the pressure fluctuations in the liquid being fed from the tank to the ejecting head,
at least surfaces of the droplet inlet, the droplet outlet, the channel, and the pressure absorbing portion that are arranged to contact the liquid being formed of a corrosion-resistant material that resists corrosion by the liquid.

2. The pressure absorbing apparatus according to claim 1, wherein
the corrosion-resistant material is at least one material selected from the group consisting of polyethylene, polypropylene, fluororesin, polyoxymethylene, cyclic olefin copolymer, and polyparaphenylene benzoxazole.

3. An ejector apparatus comprising:
a tank that feeds a liquid;
an ejecting head that ejects the liquid fed from the tank onto an ejection object; and
a pressure absorbing apparatus including
a droplet inlet connected to the tank,
a droplet outlet fluidly connected to the ejecting head,
a channel fluidly connecting the droplet inlet to the droplet outlet, and
a pressure absorbing portion in communication with the channel,
the pressure absorbing apparatus absorbing the pressure fluctuations in the liquid being fed from the tank to the ejecting head,
at least surfaces of the droplet inlet, the droplet outlet, the channel, and the pressure absorbing portion that are arranged to contact the liquid being formed of a corrosion-resistant material that resists corrosion by the liquid.

4. The ejector apparatus according to claim 3, wherein
the corrosion-resistant material is at least one material selected from the group consisting of polyethylene, polypropylene, fluororesin, polyoxymethylene, cyclic olefin copolymer, and polyparaphenylene benzoxazole.

5. The ejector apparatus according to claim 3, wherein
the ejecting head and the droplet outlet of the pressure absorbing apparatus are linked via a rubber bushing having at least a surface of the rubber bushing arranged to contact with the liquid being formed of a corrosion-resistant material that resists corrosion by the liquid.

6. The ejector apparatus according to claim 5, wherein
the corrosion-resistant materials are at least one material selected from the group consisting of fluororubber, fluororesin, elastomer, butyl rubber, and silicone rubber.

7. A method of manufacturing a device, comprising:
providing a substrate; and
ejecting a material toward the substrate to form a layer of the material above the substrate,
the ejecting of the material being performed by an ejector apparatus including a tank that feeds the material, an ejecting head that ejects the material fed from the tank onto an ejection object, and a pressure absorbing apparatus including
a droplet inlet fluidly connected to the tank,
a droplet outlet fluidly connected to the ejecting head,
a channel fluidly connecting the droplet inlet to the droplet outlet, and
a pressure absorbing portion in communication with the channel,
the pressure absorbing apparatus absorbing the pressure fluctuations in the material being fed from the tank to the ejecting head,
at least surfaces of the droplet inlet, the droplet outlet, the channel, and the pressure absorbing portion that are arranged to contact the material being formed of a corrosion-resistant material that resists corrosion by the material.

8. A method of manufacturing an electrooptical device including an electroluminescence element, comprising:
providing a substrate with a plurality of electrodes; and
ejecting a material for a light emitting layer of the electroluminescence element toward the substrate to form a plurality of the light emitting layers above the substrate,
the ejecting of the material being performed by an ejector apparatus including a tank that feeds the material, an ejecting head that ejects the material fed from the tank onto an ejection object, and a pressure absorbing apparatus including
a droplet inlet fluidly connected to the tank,
a droplet outlet fluidly connected to the ejecting head,
a channel fluidly connecting the droplet inlet to the droplet outlet, and
a pressure absorbing portion in communication with the channel,
the pressure absorbing apparatus absorbing the pressure fluctuations in the material being fed from the tank to the ejecting head,
at least surfaces of the droplet inlet, the droplet outlet, the channel, and the pressure absorbing portion that are arranged to contact the material being formed of a corrosion-resistant material that resists corrosion by the material.

9. A method of manufacturing an electrooptical device including a color filter, comprising:
providing a substrate; and
ejecting a material for the color filter toward the substrate to form the color filter above the substrate,
the ejecting of the material being performed by an ejector apparatus including a tank that feeds the material, an ejecting head that ejects the material fed from the tank onto an ejection object and a pressure absorbing apparatus including
a droplet inlet fluidly connected to the tank,
a droplet outlet fluidly connected to the ejecting head,
a channel fluidly connecting the droplet inlet to the droplet outlet, and
a pressure absorbing portion in communication with the channel,
the pressure absorbing apparatus absorbing the pressure fluctuations in the material being fed from the tank to the ejecting head,
at least surfaces of the droplet inlet, the droplet outlet, the channel, and the pressure absorbing portion that are arranged to contact the material being formed of a corrosion-resistant material that resists corrosion by the material.

10. A method of manufacturing an electronic apparatus equipped with a device, comprising:
forming the device with a substrate;
the formation of the device including ejecting a material toward the substrate to form a layer of the material above the substrate,
the ejecting of the material being performed by an ejector apparatus including a tank that feeds the material, an ejecting head that ejects the material fed from the tank onto an ejection object, and a pressure absorbing apparatus including
a droplet inlet fluidly connected to the tank,
a droplet outlet fluidly connected to the ejecting head,
a channel fluidly connecting the droplet inlet to the droplet outlet, and
a pressure absorbing portion in communication with the channel,
the pressure absorbing apparatus absorbing the pressure fluctuations in the material being fed from the tank to the ejecting head,
at least surfaces of the droplet inlet, the droplet outlet, the channel, and the pressure absorbing portion that are arranged to contact the material being formed of a corrosion-resistant material that resists corrosion by the material; and
combining the device with other components of the electronic apparatus.

11. The method of manufacturing the electronic apparatus according to claim 10, wherein
the device has an electrooptical device including an electroluminescence element, and
in the ejecting of the material, a material for a light emitting layer of the electroluminescence element is ejected to form the light emitting layer.

12. The method of manufacturing the electronic apparatus according to claim 10, wherein
the device has an electrooptical device including a color filter, and
in the ejecting of the material, a material for the color filter is ejected to form the color filter.
